(19) United States
(12) Patent Application Publication
(10) Pub. No.: US 2022/0143865 A1
(43) Pub. Date: May 12, 2022

(54) Extruder Head, Extruder System and Use of an Extruder Head and/or an Extruder System

(71) Applicant: Putzmeister Engineering GmbH, Aichtal (DE)

(72) Inventors: Tobias HUTH, Stuttgart (DE); Knut KASTEN, Ostfildern (DE); Werner TAUSCH, Koengen (DE)

(21) Appl. No.: 17/440,570

(22) PCT Filed: Mar. 25, 2020
(86) PCT No.: PCT/EP2020/058307

§ 371 Date: Sep. 17, 2021

(30) Foreign Application Priority Data
Mar. 27, 2019 (DE) 10 2019 204 236.8

(51) Int. Cl. B28B 3/26; B28B 1/00; E04G 21/04

(52) U.S. Cl. CPC B28B 3/2681; B28B 1/001; B33Y 30/00; E04G 2021/049; E04G 21/0463

(57) ABSTRACT

An extruder head for extruding a strand of building material for 3D printing of a structural part. The extruder head has an extruder nozzle with a discharge opening for discharging the strand of building material out of the extruder head in a discharge direction, a specification element designed to be variably adjustable for variably settably specifying at least a part of a strand cross section of the strand of building material being discharged, and a setting apparatus designed for variably setting the at least one specification element. The setting apparatus is designed and arranged such that the extruder head, in a first extent direction which differs from the discharge direction, extends below the discharge opening, in the case of a maximum opening height, by at most the maximum opening height, and/or, in at least one second extent direction differing from the discharge direction, extends to the side of the discharge opening, in the case of a maximum opening width, by at most the maximum opening width.

### FIELD OF APPLICATION AND PRIOR ART

The invention relates to an extruder head for the extrusion of a strand of building material for 3D printing of a structural part, to an extruder system having such an extruder head, and to the use of such an extruder head and/or of such an extruder system.

### Problem and Solution

The problem addressed by the invention is that of providing an extruder head for the extrusion of a strand of building material for 3D printing of a structural part, which extruder head has improved characteristics, in particular allows more degrees of freedom. A further problem addressed by the invention is that of providing an extruder system having such an extruder head and the use of such an extruder head and/or of such an extruder system.

The invention solves this problem by providing an extruder head, an extruder system, and a use of the extruder head, according to the independent claims. Advantageous refinements and/or configurations of the invention are described in the dependent claims.

The extruder head according to the invention is designed or configured for the extrusion of a strand of building material for 3D printing of an in particular 3-dimensional structural part. The extruder head has an extruder nozzle, at least one specification element, in particular a shape specification element, and at least one in particular controllable and/or electrical setting apparatus or adjusting apparatus. The extruder nozzle has a discharge opening for the discharge of the strand of building material out of the extruder head, in particular the extruder nozzle, in an in particular non-vertical in particular horizontal discharge direction. The at least one specification element is designed or configured or mounted to be in particular individually or separately, variably, in particular continuously, settable or adjustable, in particular movable, in particular into at least two different settings, for the purposes of variably, in particular continuously, settably and/or adjustably specifying, in particular specifying the shape, of at least one part, in particular of an edge, of a strand cross section, in particular of an area of the strand cross section of the strand of building material that is being discharged and in particular has been discharged, in particular during the discharge of the strand of building material. The at least one setting apparatus is designed or configured for in particular automatically, variably, in particular continuously setting or adjusting the at least one specification element and is designed and arranged such that the extruder head, in a first, in particular non-horizontal, in particular vertical extent direction or circumferential direction which differs from the discharge direction, extends below the discharge opening, in the case of maximum opening height, by at most the maximum opening height, and/or, in at least one second, in particular non-vertical, in particular horizontal extent direction or circumferential direction which differs from the discharge direction, extends to the side of the discharge opening, in the case of maximum opening width, by at most the maximum opening width.

In particular, the extruder head, in particular the extruder nozzle, may be designed or configured for the extrusion or for the discharge of the strand of building material out of the extruder head, in particular the extruder nozzle, in particular the discharge opening, in the non-vertical, in particular horizontal discharge direction. In other words: the extruder head, in particular the extruder nozzle, does not need to be, or may not be, designed or configured for the extrusion or for the discharge of the strand of building material out of the extruder head, in particular the extruder nozzle, in particular the discharge opening, in a vertical discharge direction. Further additionally or alternatively, the extruder head may be designed to deposit the discharged strand such that the in particular deposited strand maintains its strand cross section, in particular of the discharged strand. In other words: the extruder head does not need to be, or may not be, designed such that the building material needs to be, or can be, printed onto an already existing building material layer or ply and thus deformed.

The in particular discharged strand may be continuous or may extend over an in particular certain length.

The building material may be concrete, in particular fresh concrete, and/or thixotropic and/or set or dimensionally stable, in particular during the discharge. Further additionally or alternatively, the building material may have a maximum grain size of a minimum of 4 millimeters (mm), in particular of a minimum of 10 mm, in particular of a minimum of 16 mm.

3D printing can be referred to as additive manufacturing. Additionally or alternatively, the strand may be deposited or applied, in particular in layers, on or onto an already extruded strand, and/or a further strand may be deposited or applied, in particular in layers, on or onto the strand.

The structural part may be a building structural part and/or a wall and/or a ceiling. Additionally or alternatively, the strand, in particular a width of the strand, may comprise the thickness of the wall and/or ceiling, in particular the entire thickness.

The extruder nozzle, in particular the discharge opening, may be tubular and/or peripherally closed, in particular in/counter to the at least one extent direction, in particular by at least one peripheral wall. Additionally or alternatively, the extruder nozzle may have the discharge opening at an in particular face-side and/or front end. Further additionally or alternatively, the discharge opening can be referred to as a dispensing opening or application opening. Further additionally or alternatively, the discharge opening may be planar or flat. Further additionally or alternatively, the in particular maximum opening height may be at least 15 mm, in particular at least 25 mm, and/or at most 400 mm, in particular at most 200 mm, in particular at most 100 mm, in particular 50 mm, in particular in the first extent direction. Further additionally or alternatively, the in particular maximum opening width may be at least 100 mm, in particular at least 200 mm, and/or at most 800 mm, in particular at most 600 mm, in particular 400 mm, in particular in the second extent direction. Further additionally or alternatively, the discharge opening may have a quadrangular shape, in particular a trapezoidal shape, in particular a parallelogram shape, in particular a rectangular shape. Further additionally or alternatively, the extruder nozzle may specify the discharge direction of the strand of building material out of the extruder head, in particular the extruder nozzle, in particular the discharge opening. In particular, the discharge direction may be parallel, in particular coaxial, with respect to a longitudinal axis of the extruder nozzle.

The at least one specification element may differ from the extruder nozzle. Additionally or alternatively, the at least one specification element may be designed to be variably settable without the use of tools.

The strand cross section, in particular a shape and/or a size of the strand cross section, may at least partially, in particular entirely, correspond, in particular equate, to a flow cross section, in particular a shape and/or a size of the flow cross section, of building material within the extruder nozzle. Additionally or alternatively, the strand cross section, in particular a shape and/or a size of the strand cross section, may at least partially, in particular entirely, correspond, in particular equate, to an opening cross section, in particular a shape and/or a size of the opening cross section, of the discharge opening, in particular of an uncovered part of the discharge opening. Further additionally or alternatively, the strand cross section and/or the flow cross section and/or the opening cross section may in particular each be non-parallel, in particular orthogonal, with respect to the discharge direction.

The extruder head may extend to both, in particular opposite, sides of the discharge opening, in the case of maximum opening width, by at most the maximum opening width. Additionally or alternatively, the extruder head may, in the first extent direction, extend below the discharge opening, in the case of maximum opening height, by at most one half, in particular one quarter, in particular one eighth, of the maximum opening height and/or by 15 mm and/or, in the at least one second extent direction, may extend to the side of the discharge opening, in the case of maximum opening width, by at most one half, in particular one quarter, in particular one eighth, of the maximum opening width and/or by 100 mm. Further additionally or alternatively, the first extent direction may be orthogonal with respect to the discharge direction and/or the second extent direction may be orthogonal with respect to the discharge direction and/or the first extent direction. Further additionally or alternatively, the extruder nozzle may have at least one peripheral wall. The extent of the extruder head in the first extent direction may be defined or delimited by the peripheral wall. The discharge opening may be peripherally defined or delimited, in particular at least partially, in particular in the first extent direction, by the peripheral wall. Further additionally or alternatively, the extruder head does not need to, or may not, in the first extent direction, extend below, and/or, in the at least one second extent direction, extend to the side of, the extruder nozzle, in particular the discharge opening.

This, in particular the at least one specification element, allows different strand cross sections, in particular different shapes and/or sizes of the strand cross section or of the strand cross sections. In particular, this can allow the implementation of different wall and/or ceiling thicknesses, in particular with a transition without a shoulder, and/or the printing of the structural part with slots, holes or channels, in particular for lines or cables and/or pipes or for media such as electricity and/or water. These therefore do not need to be produced, in particular in laborious fashion, if this is possible at all with reasonable effort, at a time after the printing, in particular by work operatives.

This, in particular the extent below the discharge opening, allows the strand to be extruded, in particular in the horizontal discharge direction, at a relatively short distance, in particular vertically above an already extruded strand, in particular without damaging the latter, and thus allows the strand which is being discharged and in particular has been discharged to be deposited from a relatively low height. Additionally or alternatively, this, in particular the extent to the side of the discharge opening, allows the strand to be extruded, in particular in the horizontal discharge direction, at a relatively short distance in particular horizontally to the side of an already extruded strand, in particular without damaging the latter, and thus allows the strand which is being discharged and in particular has been discharged to be deposited from a relatively low height.

The extruder head thus has improved characteristics, in particular allows more degrees of freedom.

In one refinement, the at least one setting apparatus has at least one in particular electric and/or hydraulic and/or pneumatic setting motor or adjusting motor. The at least one setting motor is designed or configured for in particular automatically, variably, in particular continuously setting or adjusting the at least one specification element.

The at least one setting motor is arranged, counter to the first extent direction, above, counter to the discharge direction, behind, and/or, counter to the at least one second extent direction, to the side of, the extruder nozzle.

Additionally or alternatively, the extruder nozzle has, proceeding from the discharge opening in the case of maximum opening height and/or maximum opening width, counter to the discharge direction, a taper counter to the first and/or at least one second extent direction. The at least one setting motor is arranged below and/or to the side of the extruder nozzle at the taper.

In one embodiment of the invention, the at least one setting apparatus has at least one movement deflecting mechanism, in particular at least one lever mechanism and/or at least one belt, chain and/or toothed gear mechanism. The at least one setting motor is connected in terms of movement or operatively connected to the at least one specification element by means of the at least one movement deflecting mechanism.

Additionally or alternatively, the at least one setting apparatus has at least one linear drive, in particular a threaded spindle drive, and/or at least one rotary drive or pivoting drive. The at least one setting motor is connected in terms of movement or operatively connected to the at least one specification element by means of the at least one linear drive and/or by means of the at least one rotary drive.

In particular, the at least one movement deflecting mechanism and/or the at least one linear drive and/or the at least one rotary drive may in particular in each case be designed or configured to particular automatically, variably, in particular continuously set or adjust the at least one specification element.

In one refinement of the invention, the extruder nozzle has multiple peripheral walls. The peripheral walls peripherally define or delimit the discharge opening. The at least one specification element has at least one of the peripheral walls. The at least one peripheral wall is designed or configured or mounted to be in particular individually or separately, variably, in particular continuously, settable or adjustable, in particular movable, in particular in/counter to the first extent direction and/or the second extent direction, for the purposes of variably, in particular continuously, settably or adjustably defining or delimiting an outer edge or outer part of an in particular shape-imparting flow cross section, in particular an area of the flow cross section, of building material within the extruder nozzle for the purposes of variably, in particular continuously, settably or adjustably specifying, in particular specifying the shape of, an outer edge or outer part of the strand cross section, in particular an area of the strand cross section, in particular during the discharge of the strand of building material. In particular, at least one of the peripheral walls may be planar or flat and/or a metal sheet. Additionally or alternatively, the peripheral walls may define or limit the outer edge.

In one embodiment of the invention, the extruder head has an expandable, in particular elastic, hose. The expandable hose is arranged and designed to seal off against a peripheral discharge of building material. In particular, the hose may be composed partially or even entirely of rubber.

In one refinement of the invention, the at least one specification element has at least one inner element. The at least one inner element is designed or configured or mounted to be in particular individually or separately, variably, in particular continuously, settable or adjustable, in particular movable, in particular in/counter to the first extent direction and/or the second extent direction, for variable, in particular continuous, settable or adjustable, in particular complete, arrangement within the extruder nozzle for the purposes of variably, in particular continuously, settably or adjustably defining or delimiting in particular at least one inner edge or inner part of an, in particular the and/or shape-imparting flow or stream cross section, in particular an area of the flow cross section, of building material within the extruder nozzle for the purposes of variably, in particular continuously, settably or adjustably specifying, in particular specifying the shape of, in particular at least one inner edge or inner part of the strand cross section, in particular an area of the strand cross section, in particular during the discharge of the strand of building material.

In particular, the at least one inner element may differ from the extruder nozzle. Additionally or alternatively, the at least one inner element may in particular either be spaced from the discharge opening, in particular by at most 50 mm, in particular by at most 20 mm, in particular by at most 10 mm, or arranged upstream of the discharge opening, in particular counter to the discharge direction, or extend in particular at most as far as the discharge opening. Further additionally or alternatively, the at least one inner element may be in particular at least partially arranged spaced apart from the extruder nozzle or at least one peripheral wall of the extruder nozzle, in particular in/counter to the at least one extent direction. In particular, the at least one inner element may extend from the extruder nozzle or from at least one peripheral wall of the extruder nozzle, in particular orthogonally, in particular in/counter to the at least one extent direction and/or inward. Further additionally or alternatively, the flow cross section, in particular an area of the flow cross section, may be at least 5 percent (%), in particular at least 10%, in particular at least 20%, in particular at least 50%, smaller than a nozzle cross section of the extruder nozzle, in particular an opening cross section of the discharge opening, in particular an area of the nozzle cross section or of the opening cross section, in particular without an inner element. Further additionally or alternatively, the inner edge may differ from the outer edge, if present.

This, in particular the at least one inner element, allows the flow cross section that differs from a nozzle cross section of the extruder nozzle, in particular from an opening cross section of the discharge opening, in particular from a shape and/or a size of the nozzle cross section or of the opening cross section, in particular without an inner element, in particular a different shape and/or a different size of the flow cross section, and thus the different strand cross section, in particular a different shape and/or a different size of the strand cross section.

In one refinement of the invention, the at least one specification element has at least one cover element. The at least one cover element is designed or configured to be in particular individually or separately, variably, in particular continuously, settable or adjustable, in particular movable, in particular in/counter to the first extent direction and/or the second extent direction, for the purposes of variably, in particular continuously, settably or adjustably covering, in particular at least and/or only, a part of the discharge opening for the purposes of variably, in particular continuously, settably or adjustably specifying, in particular specifying the shape of, at least one part or edge, in particular of an outer part or of an inner part, of the strand cross section, in particular an area of the strand cross section, by way of at least one uncovered part of the discharge opening, in particular of an opening cross section of the discharge opening, in particular of an area of the opening cross section, in particular during the discharge of the strand of building material.

In particular, the at least one cover element can be referred to as a screen or mask. Additionally or alternatively, the at least one cover element may differ from the extruder nozzle. Further additionally or alternatively, the at least one cover element may be planar or flat. Further additionally or alternatively, an in particular maximum ratio between the at least one covered part and the at least one uncovered part may be at least 0.05, in particular at least 0.1, in particular at least 0.2, in particular at least 0.5, in particular at least 1. In particular, the at least one cover element may be designed to completely cover the discharge opening. Further additionally or alternatively, the at least one covered part may have a quadrangular shape, in particular a trapezoidal shape, in particular a parallelogram shape, in particular a rectangular shape, and/or a circular segment shape, in particular a circular shape, and/or a triangular shape and/or a comb shape.

This, in particular the at least one cover element, allows the opening cross section that differs from the discharge opening and thus the strand cross section that differs from the discharge opening.

In one embodiment of the invention, the at least one cover element is designed or configured to be variably settable for the purposes of separating off, in particular cutting off, the discharged strand of building material from the extruder head, in particular from the extruder nozzle, in particular at the discharge opening. This can allow an in particular clean or smooth end of the in particular discharged and/or deposited strand, in particular at a time after the extrusion, in particular during the transposition of the extruder head, in particular between different wall elements. Additionally or alternatively, the at least one cover element may be designed to move along the discharge opening for separating-off purposes.

Additionally or alternatively, an extent of the extruder head may be defined or delimited in an in particular horizontal direction, in particular in the discharge direction, in particular towards the front, by the at least one cover element. This allows an in particular clean or smooth separating-off action and/or an in particular clean depositing of the discharged strand and/or an in particular clean or smooth connection of the strand to an already extruded strand, in particular without damaging the latter.

In one refinement of the invention, the extruder nozzle has multiple peripheral walls. The peripheral walls peripherally define or delimit the discharge opening. At least one of the peripheral walls is designed or configured or mounted in particular so as to be movable for the purposes of being peripherally pivoted open, in particular in or counter to the first extent direction. This allows simple mounting of the expandable hose, if present, and/or simple cleaning of the extruder head after the extrusion, in particular after the concreting process.

In one refinement of the invention, the extruder head has a deflecting device or a deflecting element. The deflecting device is arranged upstream of the discharge opening, in particular of the extruder nozzle, and is designed or configured to deflect a flow or a stream of building material in particular from a non-horizontal, in particular vertical, direction, in particular in the first extent direction, in particular from top to bottom, in the direction, in particular in the discharge direction, in particular from rear to front, of the discharge opening.

This, in particular the deflecting device, allows the horizontal discharge.

The extruder system according to the invention is designed or configured for the extrusion of a, in particular the, strand of building material for 3D printing of a, in particular the, structural part. The extruder system has one, in particular the, extruder head as described above.

In addition, the extruder system according to the invention has an in particular controllable movement apparatus. The movement apparatus is designed or configured for in particular automatically at least translationally moving the extruder head, in particular the extruder nozzle, the at least one specification element and the at least one setting apparatus, in particular during the discharge of the strand of building material. In particular, the movement apparatus can be referred to as positioning apparatus. Additionally or alternatively, the movement apparatus may have or be a movement or robot arm or a mast. Additionally or alternatively, the movement apparatus and/or the extruder head may be designed for in particular automatically rotationally moving the extruder head, in particular the extruder nozzle, the at least one specification element and the at least one setting apparatus, in particular during the discharge of the strand of building material.

In one refinement of the invention, the movement apparatus is designed or configured to move the extruder head in an in particular non-vertical, in particular horizontal movement direction. The extruder head is designed or configured for the discharge of the strand of building material out of the extruder head, in particular the extruder nozzle, in particular the discharge opening, in the discharge direction, which is non-orthogonal, in particular reversed, in particular opposite, with respect to the movement direction, in particular during the movement.

Additionally or alternatively, the extruder system, in particular the extruder head, is designed or configured for the discharge of the strand of building material out of the extruder head, in particular the extruder nozzle, in particular the discharge opening, with an in particular variable in particular continuously settable or adjustable discharge speed. The movement apparatus is designed or configured to move the extruder head at a movement speed approximately equal to the discharge speed, in particular during the discharge.

This, in particular the approximately equal movement speeds, makes it possible for the discharged and/or deposited strand to maintain its strand cross section which in particular corresponds, in particular equates, to the flow cross section and/or the opening cross section.

In particular, reversed can mean a minimum of 135 degrees (°), in particular a minimum of 150°, in particular 165°. Additionally or alternatively, opposite can mean 180°. Further additionally or alternatively, approximately can mean a difference or a deviation of at most 5 percent (%), in particular of at most 2%, in particular of at most 1%.

Additionally or alternatively, the extruder system according to the invention has an in particular controllable building material pump. The building material pump is designed or configured to in particular automatically convey building material out of the extruder head, in particular the extruder nozzle, in particular the discharge opening. In particular, the extruder system may comprise a building material conveying line, wherein the building material conveying line may connect the building material pump to the extruder head, in particular the extruder nozzle, for a flow or a stream of building material from the building material pump through the building material conveying line to the extruder head, in particular the extruder nozzle. Additionally or alternatively, the building material pump may be discontinuous, in particular a piston pump, in particular a two-piston pump, in particular having a pipe switch.

Additionally or alternatively, the extruder system according to the invention has an in particular electrical control device, in particular a computer. The control device is designed or configured to in particular automatically and/or independently control the at least one in particular controllable setting apparatus and/or the in particular controllable movement apparatus and/or the in particular controllable building material pump in a manner dependent on data, in particular a building or construction plan, in particular in a memory of the control device, of the structural part to be printed. This makes it possible that a work operative does not need to control the extruder system, and/or that errors during the construction process can be reduced or even avoided.

Furthermore, the invention relates to the use of an, in particular the, extruder head and/or of an, in particular the, extruder system as described above for the extrusion of a, in particular the, strand of building material for 3D printing of a, in particular the, structural part.

### BRIEF DESCRIPTION OF THE DRAWINGS

Further advantages and aspects of the invention will emerge from the claims and from the following description of preferred exemplary embodiments of the invention, which are discussed below with reference to the figures.

FIG. 1 shows a perspective view of an extruder system according to the invention with an extruder head according to the invention.

FIG. 2 shows a further perspective view of the extruder system with the extruder head of FIG. 1.

FIG. 3 shows a front view of the extruder system with the extruder head of FIG. 1 with at least one peripheral wall in a first setting, at least one inner element in a first setting and at least one cover element in a second setting,

FIG. 4 shows a side view of the extruder system with the extruder head of FIG. 3.

FIG. 5 shows a front view of the extruder system with the extruder head of FIG. 1 with the at least one peripheral wall in the first setting, the at least one inner element in a second setting and the at least one cover element in a first setting, without an upper peripheral wall and without a hose.

FIG. 6 shows a perspective view of the extruder system with the extruder head of FIG. 5,

FIG. 7 shows a front view of the extruder system with the extruder head of FIG. 1 with the at least one peripheral wall in a second setting and the at least one inner element in the first setting, without an upper peripheral wall, without a hose and without a cover element,

FIG. 8 shows a perspective view of the extruder system with the extruder head of FIG. 7.

FIG. 9 shows a side view of the extruder system with the extruder head of FIG. 1 with the at least one cover element in the first setting.

FIG. 10 shows a perspective view of the extruder system with the extruder head of FIG. 1 with a pivoted-open upper peripheral wall and a pivoted-open lower peripheral wall and with a hose, without a cover element and without a setting apparatus.

FIG. 11 shows a front view of the extruder system with the extruder head of FIG. 1 with the at least one peripheral wall in the second setting, the at least one inner element in the first setting and the at least one cover element in a third setting.

FIG. 12 shows a perspective view of the extruder system with the extruder head of FIG. 11.

FIG. 13 shows a perspective view of the extruder system with the extruder head of FIG. 1 and a movement apparatus,

FIG. 14 shows a perspective view of the extruder system with the extruder head of FIG. 1 and a building material pump, in particular during use according to the invention.

FIG. 15 shows structural parts 3D-printed by the use according to the invention of an extruder head according to the invention and/or an extruder system according to the invention and composed of extruded strands of building material.

FIG. 16 shows a perspective view of a further extruder system according to the invention with a further extruder head according to the invention.

FIG. 17 shows a side view of the extruder system with the extruder head of FIG. 16.

FIG. 18 shows a perspective view of a yet further extruder system according to the invention with a yet further extruder head according to the invention.

### DETAILED DESCRIPTION OF THE EXEMPLARY EMBODIMENTS

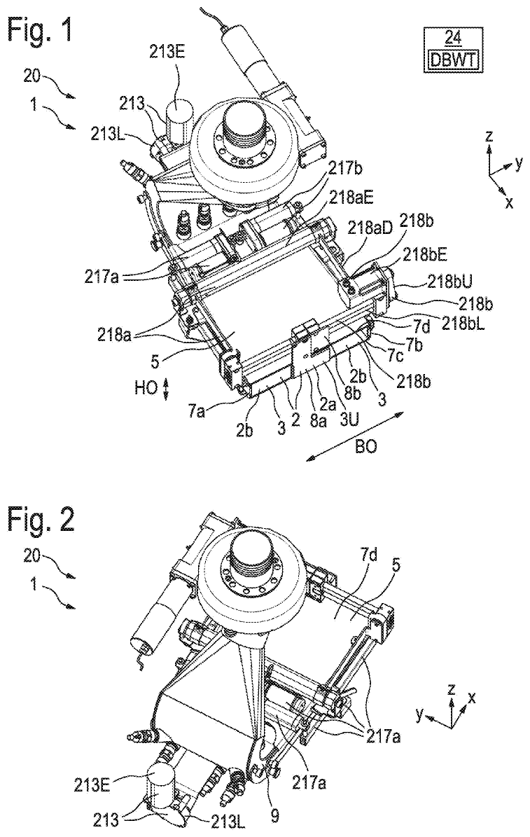

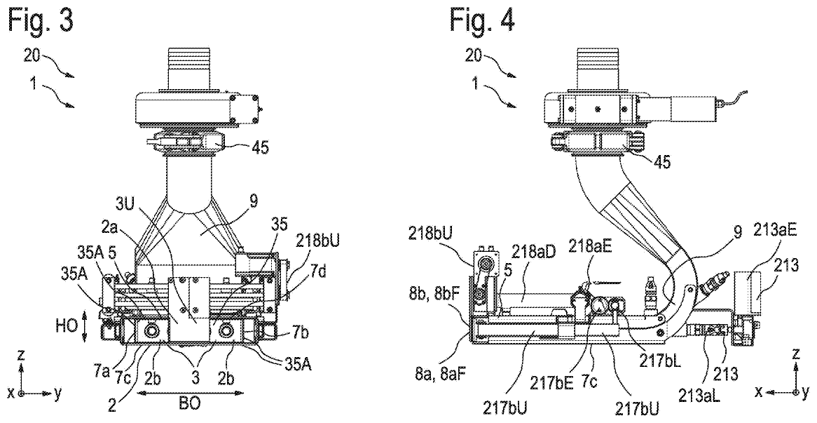

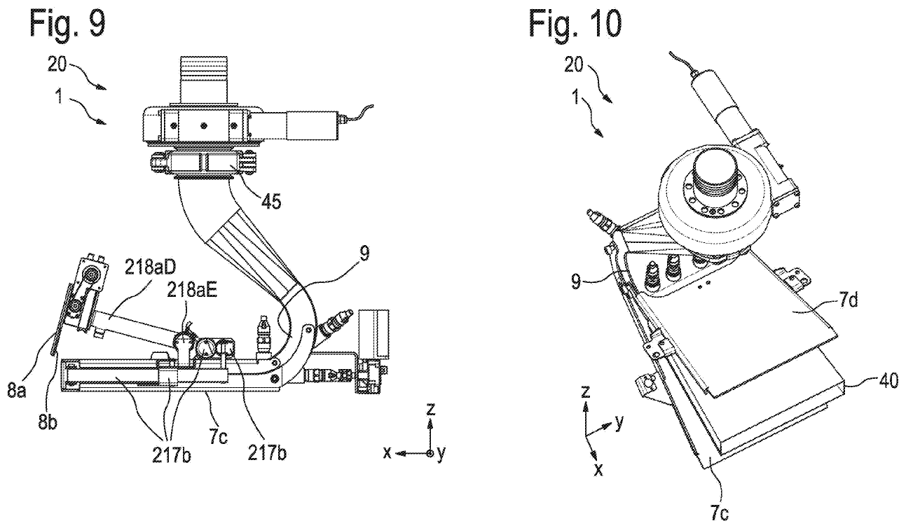

FIGS. 1 to 14 and 16 to 18 in particular each show an extruder system 20 having an extruder head 1 for extrusion of a strand ST of building material BS for 3D printing of a structural part BWT. The extruder head 1 has an extruder nozzle 5, at least one specification element 7a, 7b, 8, 8a, 8b, 30a, 30b and at least one in particular controllable setting apparatus 213, 217a, 217b, 218a, 218b. The extruder nozzle has an in particular rectangular discharge opening 2 for the discharge of the strand ST of building material BS out of the extruder head 1 in an in particular horizontal discharge direction x. The at least one specification element 7a, 7b, 8, 8a, 8b, 30a, 30b is designed to be variably adjustable for the variably adjustable specification of at least one part 4A, 4I of an in particular rectangular strand cross section 4 of the strand ST of building material BS that is being discharged. The at least one setting device 213, 217a, 217b, 218a, 218b is designed for the variable setting of the at least one specification element 7a, 7b, 8, 8a, 8b, 30a, 30b. Furthermore, the at least one setting apparatus 213, 217a, 217b, 218a, 218b is designed and arranged such that the extruder head 1, in a first, in particular vertical extent direction −z which differs from the discharge direction x, extends below the discharge opening 2, in the case of maximum opening height HO, by at most the maximum opening height HO, and/or, in at least one second, in particular horizontal extent direction −y, y which differs from the discharge direction x, extends to the side of the discharge opening 2, in the case of maximum opening width BO, by at most the maximum opening width BO.

In the exemplary embodiments shown, the extruder head 1, in the first extent direction −z, extends below the discharge opening 2, in the case of maximum opening height HO, by at most one half of the maximum opening height HO.

In detail, the extruder nozzle 5 has at least one in particular lower peripheral wall 7c. In the exemplary embodiments shown in FIGS. 1 to 14 and 18, the extent of the extruder head 1 in the first extent direction −z is defined by the in particular lower peripheral wall 7c. The discharge opening 2 is peripherally defined partially, in particular in the first extent direction −z, by the in particular lower peripheral wall 7c.

In addition, in the exemplary embodiments shown, the extruder head 1, in the at least one second extent direction −y, y, extends to the side of the discharge opening 2, in the case of maximum opening width BO, by at most one half of the maximum opening width BO.

Furthermore, in the exemplary embodiments shown, the extruder head 1 extends on both sides of the discharge opening 2, in the case of maximum opening width BO, by at most the maximum opening width BO. In alternative exemplary embodiments, the extruder head may extend only on one side of the discharge opening, in the case of maximum opening width, by at most the maximum opening width, and may extend, on the other side of the discharge opening, in particular in the case of maximum opening width, by more than the maximum opening width.

In addition, the extruder nozzle 5 has multiple peripheral walls 7a, 7b, 7c, 7d, four in the exemplary embodiments shown. The peripheral walls 7a, 7b, 7c, 7d peripherally define the discharge opening 2. The at least one specification element has at least one of the peripheral walls 7a, 7b, two in the exemplary embodiments shown. The at least one peripheral wall 7a, 7b has a variably settable design for the variably settable definition of an outer edge 35A of an in particular rectangular flow cross section 35 of building material BS within the extruder nozzle 5 for the purposes of variably settably specifying an outer edge 4A of the strand cross section 4, in particular during the discharge of the strand ST of building material BS.

In the exemplary embodiments shown, one, in particular a left-hand, peripheral wall 7a and one, in particular a right-hand, peripheral wall 7b are in particular each designed to be variably settable, in particular movable in/counter to the second extent direction −y, y, for the purposes of variably setting a width of the flow cross section 35 for the purposes of variably setting a width of the strand cross section 4 or an opening width BO of the discharge opening 2. Additionally or alternatively, in alternative exemplary embodiments, one, in particular a lower, peripheral wall and/or one, in particular an upper, peripheral wall may in particular each be designed to be variably settable, in particular movable in/counter to the first extent direction, for the purposes of variably setting a height of the flow cross section for the purposes of variably setting a height of the strand cross section or the opening height of the discharge opening.

In a first setting shown in FIGS. 1 to 6, the two peripheral walls 7a, 7b are in particular each arranged as far to the outside as possible, or with a maximum spacing to one another, such that the width of the flow cross section 35 and thus the width of the strand cross section 4 or the opening width BO of the discharge opening 2 is set to a maximum or to be wide, in the exemplary embodiments shown 400 mm.

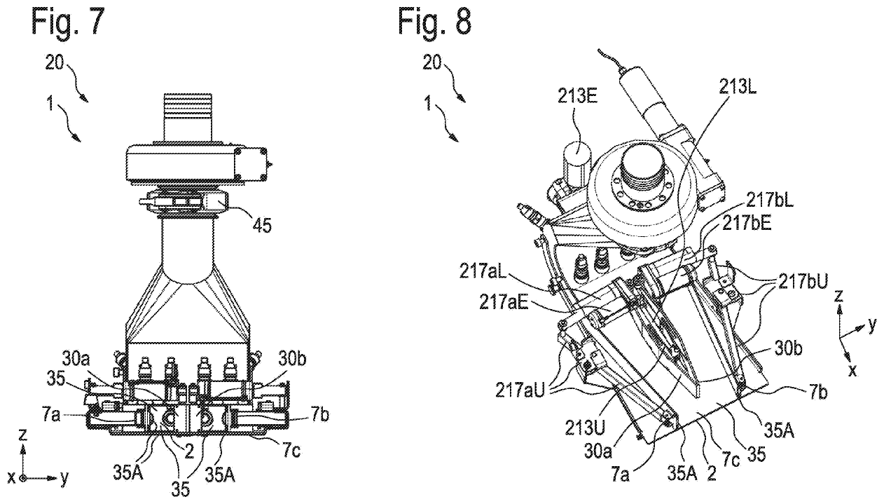

In a second setting shown in FIGS. 7, 8, 11 and 12, which in particular differs from the first setting, the two peripheral walls 7a, 7b are in particular each arranged as far to the inside as possible, or with a minimum spacing to one another, or so as to be as close together as possible, such that the width of the flow cross section 35 and thus the width of the strand cross section 4 or the opening width BO of the discharge opening 2 is set to a minimum or to be narrow, in the exemplary embodiments shown 200 mm.

In the embodiments shown, an opening height HO of the discharge opening 2 is 50 mm, in particular in the first extent direction −z.

Furthermore, the extruder head 1 has a hose 40 that is expandable, in particular by approximately a factor of 2, wherein the expandable hose 40 is arranged and designed to seal off the peripheral walls 7a, 7b, 7c, 7d against a peripheral discharge of building material BS, as shown in FIG. 10.

In addition, at least one of the peripheral walls 7c, 7d, two in the exemplary embodiments shown, is designed for being peripherally pivoted open, as shown in FIG. 10.

In the exemplary embodiments shown, an in particular lower peripheral wall 7c and an in particular upper peripheral wall 7d are in particular each designed for being peripherally pivoted open, in particular so as to be movable in/counter to the first extent direction −z, z. Additionally or alternatively, in alternative exemplary embodiments, an in particular left-hand peripheral wall and/or an in particular right-hand peripheral wall may in particular each be designed for being peripherally pivoted open, in particular so as to be movable in/counter to the second extent direction.

Furthermore, the at least one specification element has at least one inner element 30a, 30b. The at least one inner element 30a, 30b has a variably settable design, in particular is movable relative to the extruder nozzle 5, in particular in/counter to the second extent direction −y, y, for variably settable arrangement within the extruder nozzle 5 for the purposes of variably settable definition of in particular at least one inner edge 35I of the flow cross section 35 of building material BS within the extruder nozzle 5 for the purposes of variably settable specification of in particular at least one inner edge 4I the strand cross section 4, in particular during the discharge of the strand ST of building material BS. In alternative exemplary embodiments, the at least one inner element may additionally or alternatively be movable in/counter to the first extent direction.

In the exemplary embodiments shown, the at least one specification element has in particular exactly two inner elements 30a, 30b. In alternative exemplary embodiments, the at least one specification element may have in particular only one or at least three inner elements.

In detail, the at least one inner element 30a, 30b, in a first, in particular inner, setting, in particular does not specify an inner edge of the flow cross section 35 and thus does not specify an inner edge of the strand cross section 4, as shown in FIGS. 7, 8, 11 and 12 and FIG. 15 a), b) at the bottom and top, c) at the bottom and top, d) at the bottom and e) at the bottom and in the middle.

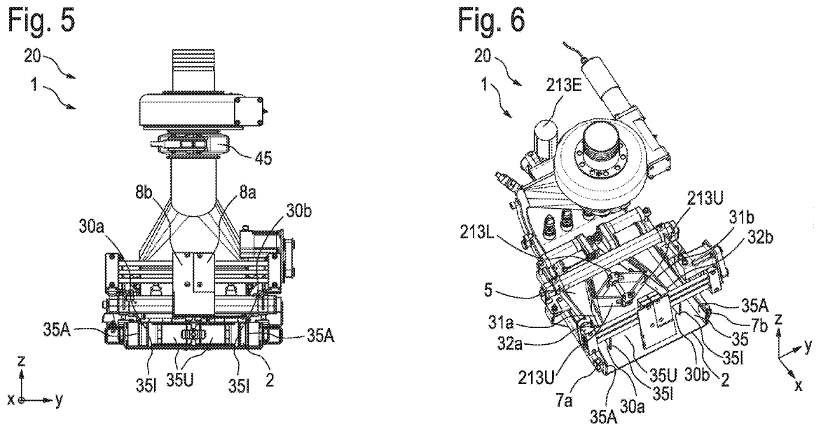

Additionally or alternatively, in a second, in particular outer setting, the at least one inner element 30a, 30b specifies a division into two parts by means of an in particular rectangular interruption 4U, in particular in an in particular horizontal direction, in particular in the second extent direction −y, in particular of the flow cross section 35, and thus of the strand cross section 4, as shown in FIGS. 5 and 6 and FIG. 15 b) in the middle, c) in the middle, d) in the middle and at the top and e) at the top.

In the exemplary embodiments shown, the interruption 4U is entirely above the in particular maximum opening height HO of the discharge opening 2. In alternative exemplary embodiments, the interruption may be in particular only partially above the in particular maximum opening height of the discharge opening.

Furthermore, the two inner elements 30a, 30b are designed to be settable, in particular into the first setting and the second setting, for the purposes of variable arrangement with respect to one another for the purposes of variably setting the inner edge 35I of the flow cross section 35.

In the exemplary embodiments shown, in the first setting, the two inner elements 30a, 30b, in particular partially or by way of ends at the side of the discharge opening, are arranged close together or lie against one another. Thus, in the first setting, the two inner elements 30a, 30b do not specify an inner edge of the flow cross section 35, in particular close to or in the region of the discharge opening 2, and thus do not specify an inner edge of the strand cross section 4. In particular, the flow cross section 35 without an inner edge, in particular close to or in the region of the discharge opening 2, specifies the strand cross section 4 without an inner edge.

Additionally or alternatively, in the second setting, the two inner elements 30a, 30b, in particular partially or by way of the ends at the side of the discharge opening, are arranged remote from one another, in particular in/counter to the second extent direction −y, y. Thus, in the second setting, the two inner elements 30a, 30b specify a division into two parts with an in particular rectangular interruption 35U, in particular in an in particular horizontal direction, in particular in the second extent direction −y, of the flow cross section 35, in particular close to or in the region of the discharge opening 2, and thus the division into two parts, with the interruption 4U, of the strand cross section 4. In particular, the two-part flow cross section 35 with the interruption 35U, in particular close to or in the region of the discharge opening 2, specifies the two-part strand cross section 4 with the interruption 4U.

In addition, the at least one inner element 30a, 30b has in particular in each case one in particular planar or flat flow-directing surface 31a, 31b for directing the flow, or flow-guiding surface for guiding the flow, of building material BS within the extruder nozzle 5 for the purposes of defining the inner edge 35I of the flow cross section 35. The in particular at least one flow-directing surface 31a, 31b is designed, in particular oriented in the exemplary embodiments shown, for non-orthogonal, in particular parallel, orientation with respect to the discharge direction x.

Furthermore, the at least one inner element 30a, 30b is in particular in each case one in particular planar or flat inner wall 32a, 32b, in particular a metal sheet.

In particular, the at least one inner element 30a, 30b is designed, in particular arranged, for arrangement within the hose 40.

Furthermore, the at least one specification element comprises at least one in particular rectangular cover element 8, 8a, 8b. The at least one cover element 8, 8a, 8b has a variably settable design, in particular is movable, in particular in/counter to the first extent direction −z, z and/or second extent direction −y, y, relative to the discharge opening 2 or the extruder nozzle 5, for the variably settable covering of at least one part 2a of the discharge opening 2 for the variably adjustable specification of at least one part 4A, 4I, in particular of the outer edge 4A and/or of the inner edge 4I, of the strand cross section 4 by at least one uncovered part 2b of the discharge opening 2, in particular of an opening cross section 3 of the discharge opening 2, in particular during the discharge of the strand ST of building material BS.

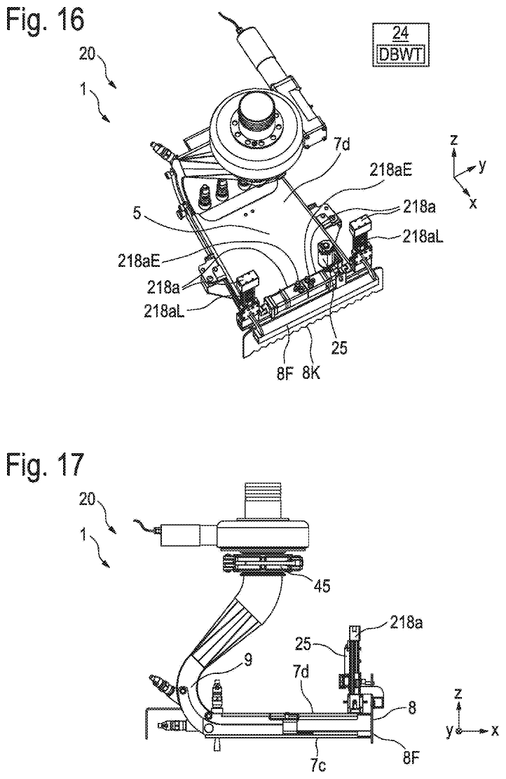

In the exemplary embodiment shown in FIGS. 1 to 14, the at least one specification element has in particular exactly two in particular rectangular cover elements 8a, 8b. In the exemplary embodiment shown in FIGS. 16 and 17, the at least one specification element has in particular exactly one in particular rectangular cover element 8. In alternative exemplary embodiments, the at least one specification element may have at least three cover elements.

Furthermore, in the exemplary embodiment shown in FIGS. 1 to 14, the at least one cover element 8a, 8b is designed to cover the, in particular at least one, part 2a of the discharge opening 2 such that the opening cross section 3 is at least divided into two parts with an interruption 3U, in particular in an in particular horizontal direction, in particular in the second extent direction −y. In particular, the interruption 3U may extend over the full, in particular maximum, opening height HO.

In detail, the at least one cover element 8, 8a, 8b is designed to be variably settable for the purposes of separating off, in particular cutting off, the discharged strand ST of building material BS from the extruder head 1, in particular at the discharge opening 2.

In the exemplary embodiments shown, the at least one cover element 8, 8a, 8b has a cutting plate or a blade 8K, 8aK, 8bK.

Furthermore, in the exemplary embodiments shown, the at least one cover element 8, 8a, 8b is designed to be arranged on the discharge opening 2, in particular so as to be in contact with the extruder nozzle 5. This makes it possible to reduce or even avoid an unintended escape of building material out of the extruder head, in particular the extruder nozzle, at an unintended location and/or in/counter to the first extent direction and/or the second extent direction.

In a second setting shown in FIGS. 1 to 4, the two cover elements 8a, 8b are arranged on the discharge opening 2 and cover an in particular inner and/or rectangular part 2a of the discharge opening 2 such that the opening cross section 3 is in particular rectangular and is divided into two parts with an in particular rectangular interruption 3U, in particular in the second extent direction −y. In other words: two parts 2b of the discharge opening 2, which are in particular outer parts or parts separated from one another by the two cover elements 8a, 8b, are uncovered. In detail, the cover elements 8a, 8b overlap or are pushed one over the other in the discharge direction x. The two-part, in particular rectangular opening cross section 3 with the in particular rectangular interruption 3U thus specifies the two-part, in particular rectangular, strand cross section 4 with an in particular rectangular interruption 4U of the in particular discharged strand ST of building material BS.

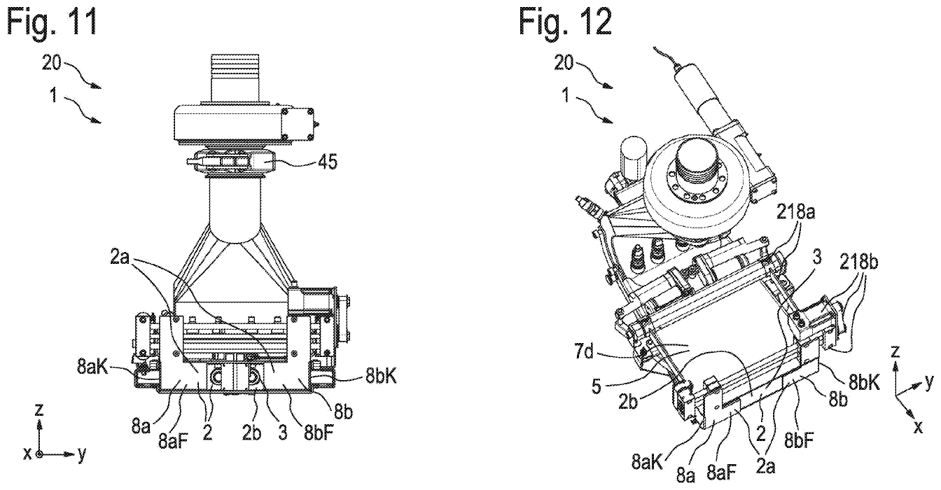

In a third setting which is shown in FIGS. 11 and 12 and which in particular differs from the second, the two cover elements 8a, 8b are arranged on the discharge opening 2 and cover two in particular outer and/or rectangular parts 2a of the discharge opening 2 such that the opening cross section 3 is in particular rectangular and narrow, in particular in the second extent direction −y. In other words: an in particular inner part 2b of the discharge opening 2 is uncovered. The narrow, in particular rectangular opening cross section 3 thus specifies the narrow, in particular rectangular strand cross section 4 of the in particular discharged strand ST of building material BS. Additionally or alternatively, by movement from/to the setting shown in FIGS. 1 to 4 to/from the setting shown in FIGS. 11 and 12 of the two cover elements 8a, 8b, in particular in/counter to the second extent direction −y, y, the in particular discharged strand ST of building material BS is separated off from the extruder head 1.

In a first setting which is shown in FIGS. 5, 6 and 9 and which in particular differs from the second and third, the two cover elements 8a, 8b are not arranged on the discharge opening 2 and do not cover any part of the discharge opening 2, or the discharge opening 2 is uncovered. In other words: the two cover elements 8a, 8b have been lifted off counter to the first extent direction z.

In a setting shown in FIGS. 16 and 17, the cover element 8 is arranged on the discharge opening 2 and completely covers the discharge opening 2. In particular, by movement from a setting in which the cover element 8 is not arranged on the discharge opening 2 and does not cover any part of the discharge opening 2, or in which the cover element 8 has been lifted off counter to the first extent direction z, to the setting shown in FIGS. 16 and 17, in particular in the first extent direction −z, the in particular discharged strand ST of building material BS is separated off from the extruder head 1.

Furthermore, the at least one cover element 8, 8a, 8b has at least one, in particular planar or flat, cover surface 8F, 8aF, 8bF for partially covering the discharge opening 2. The at least one cover surface 8F, 8aF, 8bF is designed to be oriented non-parallel, in particular orthogonally, with respect to the discharge direction x. This allows building material to be blocked in the extruder nozzle behind the in particular at least one cover element as viewed oppositely with respect to the discharge direction.

In addition, an extent of the extruder head 1 in an in particular horizontal direction, in particular in the discharge direction x, is defined by the at least one cover element 8, 8a, 8b.

The extruder head 1 furthermore has a deflecting device 9. The deflecting device 9 is arranged upstream of the discharge opening 2 and is designed to deflect a flow of building material BS, in particular from a pipe flange 45, in the direction, in particular in the discharge direction x, of the discharge opening 2.

In detail, the deflecting device 9 has a fishhook shape, in particular deviating from an “L”. In other words: the deflecting device 9 is shaped or designed such that the pipe flange 45 is arranged centrally in/counter to the discharge direction x, −x, and in particular in/counter to the second extent direction −y, y, of the extruder head 1.

In addition, the at least one setting apparatus 213, 217a, 217b, 218a, 218b has at least one in particular electric setting motor 213E, 217aE, 217bE, 218aE, 218bE. The at least one setting motor 213E, 217aE, 217bE, 218aE, 218bE is designed for the variable setting of the at least one specification element 7a, 7b, 8, 8a, 8b, 30a, 30b.

In addition, the at least one setting motor 213E, 217aE, 217bE, 218aE, 218bE is arranged, counter to the first extent direction z, above, counter to the discharge direction −x, behind, and/or, counter to the at least one second extent direction y, −y, to the side of, the extruder nozzle 5.

Additionally or alternatively, the extruder nozzle 5 has, proceeding from the discharge opening 2 in the case of maximum opening width BO, counter to the discharge direction −x, a taper 5V counter to the at least one second extent direction y, −y. The at least one setting motor 217aE, 217bE is arranged to the side of the extruder nozzle 5 at the taper 5V. In alternative exemplary embodiments, the extruder nozzle may additionally or alternatively have, proceeding from the discharge opening, in the case of maximum opening height, counter to the discharge direction, a taper counter to the first extent direction, wherein the at least one setting motor may be arranged below the extruder nozzle at the taper.

Furthermore, the at least one setting apparatus 213, 217a, 217b, 218b has at least one movement deflecting mechanism 213U, 217aU, 217bU, 218bU, in particular at least one lever mechanism and/or at least one belt, chain and/or toothed gear mechanism. The at least one setting motor 213E, 217aE, 217bE, 218bE is connected in terms of movement to the at least one specification element 7a, 7b, 8a, 8b, 30a, 30b by means of the at least one movement deflecting mechanism.

Additionally or alternatively, the at least one setting apparatus 213, 217a, 217b, 218a, 218b has at least one linear drive 213L, 217aL, 217bL, 218bL, in particular a threaded spindle drive, and/or at least one rotary drive 218aD. The at least one setting motor 213E, 217aE, 217bE, 218aE, 218bE is connected in terms of movement to the at least one specification element 7a, 7b, 8, 8a, 8b, 30a, 30b by means of the at least one linear drive 213L, 217aL, 217bL, 218bL and/or by means of the at least one rotary drive 218aD.

In detail, in FIGS. 1 to 12, the at least one setting motor 217aE, 217bE for moving the at least one peripheral wall 7a, 7b, in particular in/counter to the second extent direction −y, y, is arranged, in particular transversely, above the extruder nozzle 5 or the peripheral wall 7d, counter to the first extent direction z. Furthermore, the at least one setting apparatus 217a, 217b for moving the at least one peripheral wall 7a, 7b, in particular in/counter to the second extent direction −y, y, has at least one movement deflecting mechanism 217aU, 217bU, in particular a lever mechanism, in particular with a two-sided and/or straight lever, and/or at least one in particular mechanical linear drive 217aL, 217bL, in particular at least one threaded spindle drive. The at least one setting motor 217aE, 217bE is connected in terms of movement to the at least one peripheral wall 7a, 7b by means of the at least one movement deflecting mechanism 217aU, 217bU and/or the at least one linear drive 217aL, 217bL.

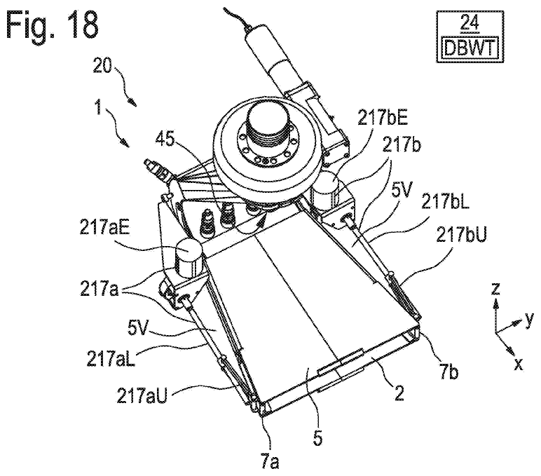

In FIG. 18, the at least one setting motor 271aE, 217bE for moving the at least one peripheral wall 7a, 7b, in particular in/counter to the second extent direction −y, y, is arranged, in particular longitudinally, to the side of the extruder nozzle 5 or of the at least one peripheral wall 7a, 7b, at the taper 5V. In addition, the at least one setting apparatus 217a, 217b for moving the at least one peripheral wall 7a, 7b, in particular in/counter to the second extent direction −y, y, has at least one movement deflecting mechanism 217aU, 217bU, in particular a lever mechanism, in particular a straight lever, and/or at least one in particular mechanical linear drive 217aL, 217bL, in particular at least one threaded spindle drive.

The at least one setting motor 217aE, 217bE is connected in terms of movement to the at least one peripheral wall 7a, 7b by means of the at least one movement deflecting mechanism 217aU, 217bU and/or the at least one linear drive 217aL, 217bL.

In the exemplary embodiment shown in particular in each case in FIGS. 1 to 12 and 18, the two peripheral walls 7a, 7b are in particular in each case designed to be mutually distinctly or individually or separately variably settable. In alternative exemplary embodiments, the two peripheral walls may be designed not to be mutually distinctly variably settable.

Furthermore, the setting motor 213 for moving the at least one inner element 30a, 30b, in particular in/counter to the second extent direction −y, y, is arranged behind the extruder nozzle 5, and in particular the deflecting device 9, counter to the discharge direction −x. Furthermore, the setting apparatus 213 for moving the at least one inner element 30a, 30b, in particular in/counter to the second extent direction −y, y, has at least one movement deflecting mechanism 213U, in particular at least one lever mechanism, in particular a knee lever, and/or an in particular mechanical linear drive 213L, in particular a threaded spindle drive. The setting motor 213E is connected in terms of movement to the at least one inner element 30a, 30b by means of the at least one movement deflecting mechanism 213U and/or the linear drive 213L.

In particular, the spindle, in particular in the deflecting device 9, is protected from the surrounding building material flow by means of a pipe.

In the exemplary embodiments shown, the two inner elements 30a, 30b are not designed to be mutually distinctly or individually or separately variably settable. In alternative exemplary embodiments, the two inner elements may in particular in each case be designed to be individually variably settable.

Furthermore, in FIGS. 1 to 12, the setting motor 218aE for moving the at least one cover element 8a, 8b, in particular in/counter to the first extent direction −z, z, is arranged above the extruder nozzle 5 or the peripheral wall 7d, counter to the first extent direction z. In addition, the setting apparatus 218a for moving the at least one cover element 8a, 8b, in particular in/counter to the first extent direction −z, z has an in particular mechanical rotary drive 218aD. The setting motor 218aE is connected in terms of movement to the at least one cover element 8a, 8b by means of the rotary drive 218aD.

Furthermore, in FIGS. 1 to 12, the setting motor 218bE for moving the at least one cover element 8a, 8b, in particular in/counter to the second extent direction −y, y, is arranged above the extruder nozzle 5 or the peripheral wall 7d, counter to the first extent direction z. Furthermore, the setting apparatus 218b for moving the at least one cover element 8a, 8b, in particular in/counter to the second extent direction −y, y, has a movement deflecting mechanism 218bU, in particular a belt mechanism, and/or an in particular mechanical linear drive 218bL, in particular a threaded spindle drive. The setting motor 218bE is connected in terms of movement to the at least one cover element 8a, 8b by means of the movement deflecting mechanism 218bU and/or the linear drive 218bL.

In alternative exemplary embodiments, the setting motor for moving the at least one cover element, in particular in/counter to the second extent direction, may be arranged to the side of the extruder nozzle, counter to the second extent direction. The setting apparatus for moving the at least one cover element, in particular in/counter to the second extent direction, may have an in particular mechanical linear drive, in particular a threaded spindle drive. The setting motor may be connected in terms of movement to the at least one cover element by means of the linear drive.

In the exemplary embodiment shown in FIGS. 1 to 12, the two cover elements 8a, 8b are not designed to be mutually distinctly or individually or separately variably settable. In alternative exemplary embodiments, the two cover elements may in particular in each case be designed to be individually variably settable.

In FIGS. 16 and 17, the at least one setting motor 218aE for moving the at least one cover element 8a, 8b, in particular in/counter to the first extent direction −z, z, is arranged above the extruder nozzle 5 or the peripheral wall 7d, counter to the first extent direction z. In addition, the setting apparatus 218b for moving the at least one cover element 8a, 8b, in particular in/counter to the second extent direction −y, y, has at least one in particular mechanical linear drive 218aL, in particular at least one threaded spindle drive. The at least one setting motor 218aE is connected in terms of movement to the cover element 8 by means of the at least one linear drive 218aL.

In addition, the extruder head 1 has an in particular controllable and/or electrical vibrating apparatus 25, as shown in FIGS. 16 and 17. The vibrating apparatus 25 is designed to in particular automatically vibrate or stimulate the cover element 8. This makes it possible to loosen or displace stones in the concrete, in particular behind the in particular at least one cover element, and thus to reduce or even avoid the risk of blocking by stones in the concrete, in particular behind the in particular at least one cover element, in particular for separating-off purposes.

In the exemplary embodiment shown in FIGS. 16 and 17, the vibrating apparatus 25 has an eccentric. In alternative exemplary embodiments, the vibrating apparatus may additionally or alternatively have an ultrasound source.

Furthermore, the extruder head 1 has a number of in particular controllable injection nozzles, in particular cyclically operated high-pressure nozzles with a pressure greater than 10 bar, in particular greater than 100 bar. The injection nozzles are designed for injecting, in particular for admixing or introducing, an additive, in particular concrete accelerator, in particular directly into the building material BS before it is discharged. This, in particular the high pressure, allows the additive to be widely distributed such that no further mixing element is required. In detail, the number of injection nozzles is arranged above the extruder nozzle 5 or the peripheral wall 7d counter to the first extent direction z and/or behind the extruder nozzle 5, and in particular the deflecting device 9, counter to the discharge direction −x. This, in particular the arrangement, makes it possible that, in pumping intervals or interruptions in the printing process, the smallest possible amount of activated building material, in particular concrete, is present in the extruder head 1 and/or has to be disposed of.

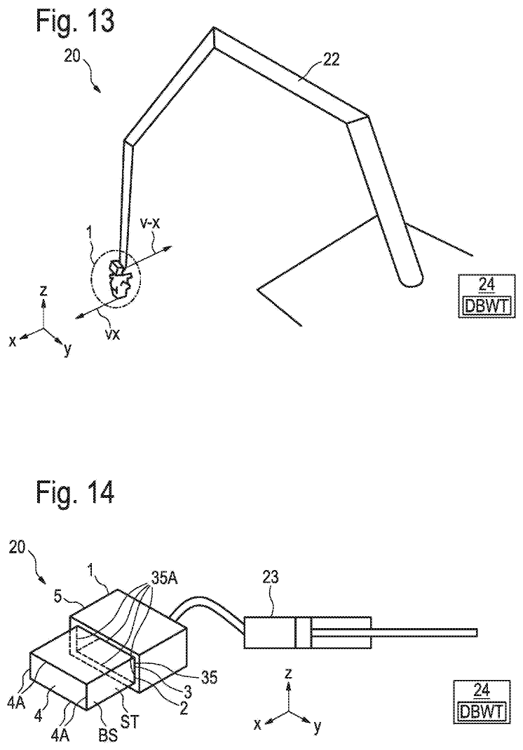

Moreover, the extruder system 20 has an in particular controllable movement apparatus 22, as shown in FIG. 13. The movement apparatus 22 is designed to at least translationally move the extruder head 1, in particular during the discharge of the strand ST of building material BS.

In the exemplary embodiment shown, the movement apparatus 22 has a movement arm. Additionally or alternatively, the movement apparatus 22 and/or the extruder head 1 are/is designed to move the extruder head 1 in rotation, in particular during the discharge of the strand ST of building material BS. In detail, the extruder head 1 is rotatable about a longitudinal axis of the pipe flange by means of an in particular electric motor and in particular a screw drive.

In detail, the movement device 22 is designed to move the extruder head 1 in an in particular horizontal movement direction −x. The extruder head 1 is designed for the discharge of the strand ST of building material BS out of the extruder head 1 in the discharge direction x which is non-orthogonal, in particular opposite, to the movement direction −x, in particular during the movement.

Additionally or alternatively, the extruder system 20, in particular the extruder head 1, is designed for the discharge of the strand ST of building material BS out of the extruder head 1 with an in particular variably settable discharge speed vx. The movement apparatus 22 is designed to move the extruder head 1 at a movement speed v-x approximately equal to the discharge speed vx, in particular during the discharge.

Furthermore, the extruder system 20 has an in particular controllable building material pump 23, as shown in FIG. 14. The building material pump 23 is designed to convey building material BS out of the extruder head 1.

In the exemplary embodiment shown, the building material pump is discontinuous, in particular a piston pump. Additionally or alternatively, the extruder system 20 has a building material conveying line, wherein the building material conveying line connects the building material pump 23 to the extruder head 1 for a stream of building material BS from the building material pump 23 through the building material conveying line to the extruder head 1.

The extruder system 20 furthermore has a control device 24. The control device 24 is designed to in particular automatically control the at least one in particular controllable setting apparatus 213, 217a, 217b, 218a, 218b and/or the in particular controllable movement apparatus 22 and/or the in particular controllable building material pump 23, and in particular the in particular controllable vibrating apparatus 25 and/or the number of in particular controllable injection nozzles, in a manner dependent on data DBWT of the structural part BWT to be printed.

Furthermore, the extruder system 20, in particular the extruder head 1, is designed to deposit the in particular discharged strand ST such that the in particular deposited strand ST maintains its strand cross section 4, in particular of the discharged strand ST.

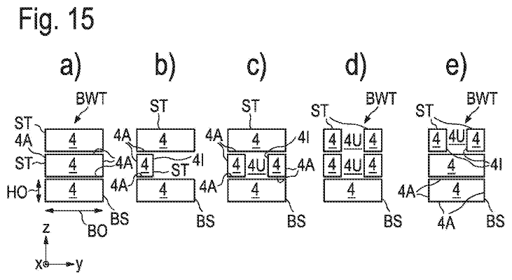

In addition, the strand ST may be deposited, in particular in layers, on an already extruded strand ST and/or a further strand ST may be deposited, in particular in layers, on the strand ST, as shown in FIG. 15.

In particular, FIGS. 14 and 15 show the use of the extruder head 1 and/or of the extruder system 20 for the extrusion of the strand ST of building material BS for 3D printing of the structural part BWT, and structural parts BWT 3D-printed by means of the extruder head 1 and/or the extruder system 20 and composed of extruded strands ST of building material BS.

In detail, the rectangular strand cross section 4 shown in particular in each case in FIG. 15 a), b) at the bottom and top, c) at the bottom and top, d) at the bottom and e) at the bottom may be specified or is specified by the peripheral walls 7a, 7b, in particular in each case in the first setting or as far to the outside as possible, the at least one inner element 30a, 30b in the first setting and the at least one cover element 8, 8a, 8b in the first setting or without a cover element.

The rectangular, two-part strand cross section 4 with rectangular interruption 4U, as shown in particular in each case in FIG. 15 c) in the middle, d) in the middle and at the top and e) at the top, may be specified or is specified by the peripheral walls 7a, 7b, in particular in each case in the first setting or as far to the outside as possible, the at least one inner element 30a, 30b in the second setting and the at least one cover element 8, 8a, 8b in the first setting or without a cover element.

Additionally or alternatively, the rectangular, two-part strand cross section 4 with rectangular interruption 4U, as shown in particular in each case in FIG. 15 c) in the middle, d) in the middle and at the top and e) at the top, may be specified or is specified by the peripheral walls 7a, 7b, in particular in each case in the first setting or as far to the outside as possible, the at least one inner element 30a, 30b in the first setting and the at least one in particular rectangular cover element 8a, 8b in the second setting or covering a middle or inner part 2a of the in particular rectangular discharge opening 2, in particular with a maximum opening width BO.

The rectangular strand cross section 4 shown in FIG. 15 b) in the middle may be specified or is specified by the peripheral wall 7a in the first setting or as far to the outside as possible, the peripheral wall 7b in the second setting or as far to the inside as possible, the at least one inner element 30a, 30b in the second setting and the at least one cover element 8, 8a, 8b in the first setting or without a cover element. In particular, the inner element 30b, in particular by way of the end at the side of the discharge opening, and the peripheral wall 7b may lie against one another, or said inner element and peripheral wall lie against one another.

Additionally or alternatively, the rectangular strand cross section 4 shown in FIG. 15 b) in the middle may be specified or is specified by the peripheral wall 7a in the first setting or as far to the outside as possible, the peripheral wall 7b in the second setting or as far to the inside as possible, the at least one inner element 30a, 30b in the first setting and the at least one in particular rectangular cover element 8a, 8b in the second setting or covering a middle or inner part 2a of the in particular rectangular discharge opening 2, in particular with a maximum opening width BO.

It is thus possible for slots to be produced vertically in a strand or a layer or a ply ST and horizontally on an outer side of the strand ST, as shown in FIG. 15, in particular b) to e). In particular, it is thus possible to generate two narrow or thin structural parts or walls BWT which are connected by means of webs and which have a passage, in order for the intermediate space to later be filled with insulation material or to accommodate installation lines. In particular, the strand cross sections 4 of FIGS. 15 c), d) and e) may be arranged in particular in this sequence in and/or counter to the discharge direction x. In addition or alternatively, it is thus possible to produce open strand cross sections 4 in order to generate a media channel. In particular, the strand cross sections 4 of FIGS. 15 a), b), c) and d) may be arranged in particular in this sequence in and/or counter to the discharge direction x. Further additionally or alternatively, a support structure such as a lattice may be arranged and/or is arranged on those strands ST which do not extend over the entire maximum opening width BO, in order to allow at least one further strand ST to be deposited. This can make it possible to prevent soft building material from sagging downward into the space, in particular hollow space.

Additionally or alternatively, joints and corners can be produced or generated. In particular, in the case of 3D printing, in particular of solid concrete structures with large dispensing quantities and a wide dispensed strand, the strand can be ended and restarted in order to generate room corners. In detail, at a corner, the preceding strand can be cut off orthogonally or perpendicularly or at an angle, and the new strand can easily be pressed against the preceding strand, or deposited there, at the corresponding angle. In particular when completing a contour circuit, it is possible here for the extruder head, in particular the extruder nozzle, to be positioned one layer or one ply or one plane higher so as not to damage or even destroy the strand that is already present. The strand can then be allowed to fall or be guided downwards. An analogous procedure can be followed in the case of a circular building structure. If the printing direction is changed between the layers or plies or planes, nesting of the ends of the strands can be achieved in the corners. This can allow clean or smooth corners with no visible transition. Additionally or alternatively, this, in particular the nesting of the strands, in the corners can allow a better binding of the strands after the hardening process, in particular both horizontally and vertically, in particular so as not to create any unintended break points.

In particular, the following procedure can be followed:

Step a1): Extruding and depositing a first strand ST1 during a translational and in particular rotational movement of the extruder head 1 in an in particular horizontal first movement direction −x, and in particular in a curve.

Step b1) Ending the extrusion and the depositing.

Step c) At least rotating or turning the extruder head 1 through an angle, in particular about an in particular vertical upright axis.

Step a2) Extruding and depositing a second strand ST2 during a translational and in particular rotational movement of the rotated extruder head 1 in an in particular horizontal second movement direction −y that differs from the first by the angle, and in particular in a curve, such that an end face FST2 of the second strand ST2 touches the first strand ST1 and/or an end face FST1 of the first strand ST1 touches the second strand ST2.

Additionally or alternatively, the following procedure may be followed:

Step a): Adjusting the strand cross section 4 during the extrusion, in particular such that the strand ST tapers at an end side SST.

Further additionally or alternatively, the following procedure may be followed:

Step a1): Extruding and depositing a first strand ST1.

Step b) Ending the extrusion and the depositing.

Step c): At least translationally moving the extruder head 1, in particular by a height of the first strand ST1, in particular upward.

Step a2): Extruding and depositing a second strand ST2 at least partially on the first strand ST1, in particular such that a base surface GST2 of the second strand ST2 touches a top surface DST1 of the first strand ST1.

In particular, step a2) may comprise: Extruding and depositing the second strand ST2 at least partially on the first strand ST1 such that at least one end face FST2 of the second strand ST2 is, in particular arranged so as to be, offset relative to an end face FST1 of the first strand ST1, or that the first strand ST1 and the second strand ST2 are mutually offset in a varied manner, or do not lie exactly one above the other.

As the exemplary embodiments shown and discussed above make clear, the invention provides an advantageous extruder head for the extrusion of a strand of building material for 3D printing of a structural part, which extruder head has improved characteristics, in particular allows more degrees of freedom. The invention furthermore provides an extruder system having such an extruder head, and the use of such an extruder head and/or of such an extruder system.

1.-15. (canceled)

16. An extruder head for extrusion of a strand of building material for 3D printing of a structural part, comprising:
an extruder nozzle, wherein the extruder nozzle has a discharge opening for discharge of the strand of building material out of the extruder head in a discharge direction;
at least one specification element, wherein the at least one specification element is designed to be variably adjustable for purposes of variably settably specifying at least a part of a strand cross section of the strand of building material being discharged; and
at least one setting apparatus, wherein the at least one setting apparatus is designed for variably setting the at least one specification element and is designed and arranged such that the extruder head, in a first extent direction which differs from the discharge direction, extends below the discharge opening, in case of a maximum opening height, by at most the maximum opening height, and/or, in at least one second extent direction which differs from the discharge direction, extends to a side of the discharge opening, in the case of a maximum opening width, by at most the maximum opening width.

17. The extruder head as claimed in claim 16, wherein
the at least one setting apparatus has at least one setting motor,
the at least one setting motor is designed for variably setting the at least one specification element,
the at least one setting motor is arranged, counter to the first extent direction, above, counter to the discharge direction, behind, and/or, counter to the at least one second extent direction, to the side of, the extruder nozzle, and
the extruder nozzle has, proceeding from the discharge opening in the case of the maximum opening height and/or the maximum opening width, counter to the discharge direction, a taper counter to the first and/or at least one second extent direction, wherein the at least one setting motor is arranged below and/or to the side of the extruder nozzle at the taper.

18. The extruder head as claimed in claim 16, wherein
the at least one setting apparatus has at least one setting motor,
the at least one setting motor is designed for variably setting the at least one specification element,
the at least one setting motor is arranged, counter to the first extent direction, above, counter to the discharge direction, behind, and/or, counter to the at least one second extent direction, to the side of, the extruder nozzle.

19. The extruder head as claimed in claim 16, wherein
the at least one setting apparatus has at least one setting motor,
the at least one setting motor is designed for variably setting the at least one specification element,
the extruder nozzle has, proceeding from the discharge opening in the case of the maximum opening height and/or the maximum opening width, counter to the discharge direction, a taper counter to the first and/or at least one second extent direction, wherein the at least one setting motor is arranged below and/or to the side of the extruder nozzle at the taper.

20. The extruder head as claimed in claim 17,
wherein the at least one setting apparatus has at least one movement deflecting mechanism, wherein the at least one setting motor is connected in terms of movement to the at least one specification element by way of the at least one movement deflecting mechanism, and/or
the at least one setting apparatus has at least one linear drive, wherein the at least one setting motor is connected in terms of movement to the at least one specification element by way of the at least one linear drive and/or by way of the at least one rotary drive.

21. The extruder head as claimed in claim 20, wherein
the at least one movement deflecting mechanism is at least one of: a lever mechanism, a belt, a chain or a toothed gear mechanism.

22. The extruder head as claimed in claim 20, wherein
the at least one linear drive is at least one of: a threaded spindle drive or a rotary drive.

23. The extruder head as claimed in claim 16, wherein
the extruder nozzle has multiple peripheral walls, wherein the peripheral walls peripherally define the discharge opening,
the at least one specification element has at least one of the peripheral walls, wherein the at least one peripheral wall is designed to be variably settable for purposes of variably settably defining an outer edge of a flow cross section of building material within the extruder nozzle for purposes of variably settably specifying an outer edge of the strand cross section during the discharge of the strand of building material.

24. The extruder head as claimed in claim 23, further comprising:
an expandable hose, wherein the expandable hose is arranged and designed to seal off the peripheral walls against a peripheral discharge of building material.

25. The extruder head as claimed in claim 16, wherein
the at least one specification element has at least one inner element,
the at least one inner element is designed to be variably settable for variably settable arrangement within the extruder nozzle for purposes of variably settably defining an inner edge of a flow cross section of building material within the extruder nozzle for purposes of variably settably specifying an inner edge of the strand cross section during the discharge of the strand of building material.

26. The extruder head as claimed in claim 16, wherein
the at least one specification element has at least one cover element,
the at least one cover element is designed to be variably settable for purposes of variably settably covering at least a part of the discharge opening for purposes of variably settably specifying at least a part of the strand cross section by way of at least one uncovered part of the discharge opening during the discharge of the strand of building material.

27. The extruder head as claimed in claim 26, wherein
the at least one cover element is designed to be variably settable for purposes of separating off the discharged strand of building material from the extruder head at the discharge opening.

28. The extruder head as claimed in claim 16, wherein
the extruder nozzle has multiple peripheral walls,
the peripheral walls peripherally define the discharge opening, and
at least one of the multiple peripheral walls is designed for being peripherally pivoted open in or counter to the first extent direction.

29. The extruder head as claimed in claim 16, further comprising:
a deflecting device, wherein the deflecting device is arranged upstream of the discharge opening and is designed to deflect a flow of building material in the direction of the discharge opening.

30. An extruder system for extrusion of a strand of building material for 3D printing of a structural part, comprising:
an extruder head as claimed in claim 16; and
a controllable movement apparatus, wherein the controllable movement apparatus is designed to at least translationally move the extruder head during discharge of the strand of building material.

31. The extruder system as claimed in claim 30, wherein
the controllable movement apparatus is designed to move the extruder head in a horizontal movement direction, and wherein the extruder head is designed to discharge the strand of building material out of the extruder head in the discharge direction, which is non-orthogonal with respect to the movement direction during the movement, and/or
the extruder head is designed for the discharge of the strand of building material out of the extruder head with a variably settable discharge speed, and wherein the controllable movement apparatus is designed to move the extruder head with a movement speed which is approximately equal to the discharge speed during the discharge.

32. An extruder system for extrusion of a strand of building material for 3D printing of a structural part, comprising:
an extruder head as claimed in claim 16; and
a controllable building material pump, wherein the building material pump is designed to convey building material out of the extruder head.

33. An extruder system for extrusion of a strand of building material for 3D printing of a structural part, comprising:
an extruder head as claimed in claim 16;
a control device, wherein the control device is designed to automatically control at least one of:
the at least one setting apparatus,
a movement apparatus, or
a building material pump, in a manner dependent on data of the structural part that is to be printed.

34. Use of an extruder head as claimed in claim 16 for extrusion of the strand of building material for the 3D printing of the structural part.
